(19) United States
(12) Patent Application Publication
(10) Pub. No.: US 2018/0261049 A1
(43) Pub. Date: Sep. 13, 2018

(54) GAMING DEVICE AND SYSTEM AND METHOD FOR PROVIDING CARD GAMES

(71) Applicant: Two Black Nines LLC, Los Angeles, CA (US)

(72) Inventors: Peter Costa, Las Vegas, NV (US); Robert W. Soderstrom, Los Angeles, CA (US); William Tricarico, Las Vegas, NV (US)

(21) Appl. No.: 15/911,794

(22) Filed: Mar. 5, 2018

Related U.S. Application Data
(60) Provisional application No. 62/468,682, filed on Mar. 8, 2017.
(60) Provisional application No. 62/479,917, filed on Mar. 31, 2017.
(60) Provisional application No. 62/565,535, filed on Sep. 29, 2017.

(51) Int. Cl. G07F 17/32; A63F 1/14

(52) U.S. Cl. CPC G07F 17/3293; A63F 2001/008; A63F 1/14

(57) ABSTRACT

A method of playing a card game with players and dealer in a computing system is provided. In the method, a first player card can be dealt face up and applied to first, second, and third player hands. A first dealer card can be dealt face down to a dealer and applied to first, second, and third dealer hands. The player can indicate whether to draw additional cards for the first, second, and third player hands. The dealer can determine, based on predetermined rules, whether to draw additional cards for the dealer hands. Winners can be determined, where the winners can be the player or dealer with closest to 11, 21, and 31 points for the first, second, and third hands, respectively. A fourth winner can be determined, where the winner can be the player or dealer with the highest three-card poker hand.

### CROSS-REFERENCE TO RELATED APPLICATIONS

This application claims the benefit of U.S. Provisional Application No. 62/468,682, filed Mar. 8, 2017 and titled CARD GAMES, and claims the benefit of U.S. Provisional Application No. 62/479,917, filed Mar. 31, 2017 and titled CARD GAMES, and claims the benefit of U.S. Provisional Application No. 62/565,535, filed Sep. 29, 2017 and titled GAMING DEVICE AND SYSTEM AND METHOD FOR PROVIDING CARD GAMES, all of which are incorporated by reference.

### BACKGROUND

Traditionally, card games often utilize a deck including 52 cards. These cards are often made of a heavy glossy paper or plastic material. The front surface of the card includes printed indicia thereon that distinguish the cards from each other. The rear surface of the card may be blank or can include a decorative design or pattern. The rear surface is typically the same on all cards so that one card can not be distinguished from another card by viewing the rear surface. Various games can be played using this standard deck of cards.

Card games are often now played in an electronic format online or utilizing an electronic gaming cabinet or video poker type machine. The present disclosure relates to a game that can be played both in the traditional format using a deck of cards or in an electronic format.

### SUMMARY OF THE INVENTION

This disclosure relates to card games. In an illustrative but non-limiting example, the disclosure provides a method of playing a card game with players and dealer in a computing system comprising at least one server to host the card game and at least one computing device communicably coupled to the at least one server through a communication network. The method can include using a traditional deck of 52 cards and dealing cards to at least one player and a dealer. In the method, a first player card can be dealt face up to a player and applied to a first player hand, a second player hand, and a third player hand. A first dealer card can be dealt face down to a dealer and applied to a first dealer hand, a second dealer hand, and a third dealer hand. The player can indicate whether to draw a second player card for the first, second, and third player hands. The dealer can reveal the first dealer card to determine whether to draw a second dealer card for the first, second, and third dealer hands. A first winner can be determined, wherein the winner can be the player or dealer with closest to 11 points. The player can indicate whether to draw an additional one or more cards for the second and third player hands. The dealer can determine, based on predetermined rules, whether to draw an additional one or more dealer cards for the second and third dealer hands. A second winner can be determined, wherein the winner can be the player or dealer with closest to 21 points. The player can indicate whether to draw an additional one or more cards for the third player hand. The dealer can determine, based on predetermined rules, whether to draw an additional one or more dealer cards for the third dealer hand. A third winner can be determined, wherein the winner can be the player or dealer with closest to 31 points. Further, a fourth winner can be determined, wherein the winner can be the player or dealer with the highest three-card poker hand.

The above summary is not intended to describe each and every example or every implementation of the disclosure. The Description that follows more particularly exemplifies various illustrative embodiments.

### BRIEF DESCRIPTION OF THE DRAWINGS

FIG. 1 illustrates an example deck of playing cards.

FIG. 2 illustrates several playing cards arranged on a table during play.

FIG. 3A is a schematic block diagram depicting an example computing system used in accordance with one embodiment of the present invention.

FIG. 3B is a schematic block diagram depicting an example computing system used in accordance with one embodiment of the present invention.

### DETAILED DESCRIPTION

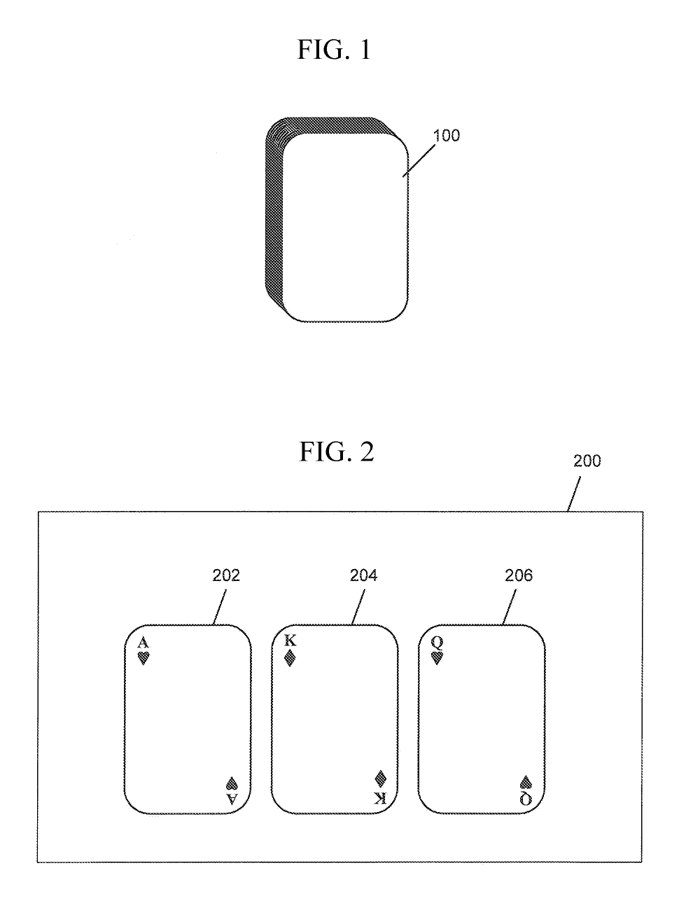

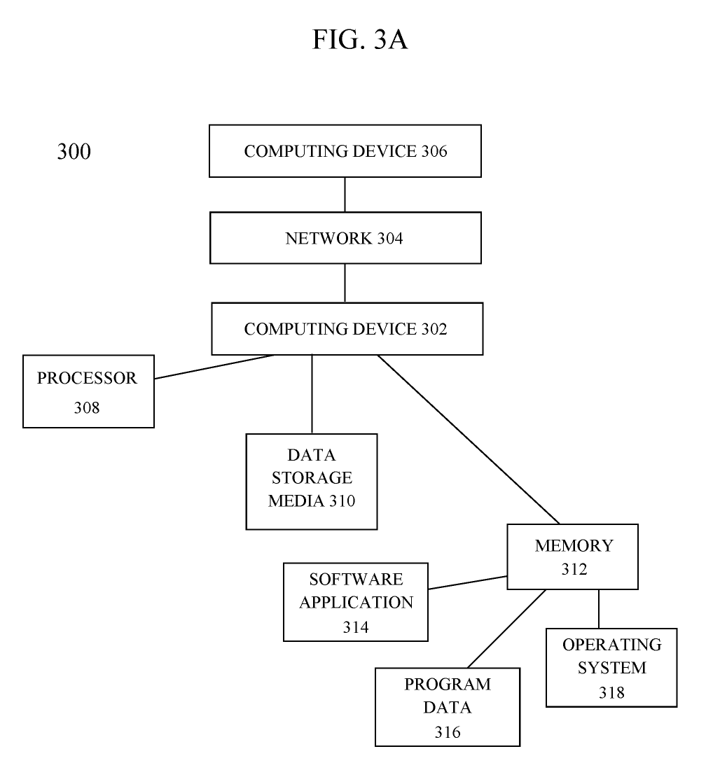

FIG. 1 illustrates an example deck of playing cards 100. A standard 52-card deck of playing cards 100 can be used in some embodiments. In other embodiments, a deck of dice whereas there are six cards in a set (from ace through to six), two colors and two suits and with 8 sets forming a deck of 48 cards. FIG. 2 shows some of playing cards 100 (202, 204 and 206) arranged on a table 200.

In some embodiments, playing cards 100 are made of paper, such as a heavy paper, thin card, or thin plastic, or may be electronically represented on a screen as though they were physical playing cards as described herein. Playing cards 100 typically include a face surface and a back surface. The face surface typically includes markings thereon that distinguish the cards from other cards in the deck. The markings are also used to determine the permissible uses of each card according to the rules of the game being played, such as discussed in more detail herein. Examples of markings include printed indicia that identify the card as being one of an Ace, 2, 3, 4, 5, 6, 7, 8, 9 10, Jack, Queen, and King, and also identify the card as being of a suit selected from diamonds, clubs, hearts, and spaces, in some embodiments.

### Triple Play Blackjack—Version One

A standard deck of 52 cards is used and all cards count at face value with ace counting as one or eleven. All picture cards count ten.

This version of blackjack offers a unique feature allowing players to play three hands of blackjack in which the same cards apply to all three wagers and outcomes. Each hand is raced against the dealer with the object of drawing cards to score a points value closest to 11 for hand (a) closest to 21 for hand (b) and closest to 31 for hand (c).

All the following rules to the three versions of Triple Play Blackjack are dependent on the final, and changes to dealer strategy may apply.

The dealer must draw further cards up to a score of six for hand (a) and stand on a score of seven or higher. For hand (b), the dealer must draw cards to a score of sixteen or soft seventeen and stand on hard seventeen and over. For hand (c), the dealer must draw further cards to a score of twenty-six or soft twenty-seven and stand on hard twenty-seven and over.

Player or dealer going over 11, 21 or 31 will be deemed to have bust and their respective wagers are lost. Player and dealer may bust on hand (a) and hand (b) but hand (c) is played out to an outcome.

When a player has bust on hands a or b, the dealer rules apply and the drawing of further cards applies. For example, if a player busts on hand (a), the dealer must complete hand (a) and either draw further cards or stand according to the dealer rules. The same applies to hand (b), and irrespective if the dealer is playing against one or more players.

Players place three equal wagers for hands a, b, c, before the deal begins. Players receive one card face up and the dealer one card face down. Based on the games rules, players must use their judgment to determine drawing more cards or to stand.

Once all players have acted, the dealer's card is revealed. Dealer plays to game rules and either draws further cards or is forced to stand. All wagers on hand (a) are settled and play continues with the same cards counting towards hand (b).

At this point and before the deal for hand (b) begins, the dealer may discard any and all cards drawn for hand (a). As an example, if the dealer was dealt a four on the first card, the rules dictate that the dealer draws further cards to complete hand (a). In this example, the dealer may have drawn a seven to score 11 on hand (a), or may have drawn a ten to bust. Irrespective, for hand (b) to play to standard blackjack and whereas the dealer would only be revealing one card face up, the seven or ten or any other cards drawn would be discarded and the dealer would begin hand two with the same card the dealer began with hand (a).

The other option is for the dealer to retain any cards on hand (a) and carry on to hand (b) points values of 11 and under. In the above example, the dealer would carry forward the 11 after drawing a seven on the four and carry over the four by discarding the ten. In effect, any card that busts the dealer's hand (a) would be discarded. In a further addition to the above example, if the dealer drew a deuce to the four, the dealer would still draw. If the next card busts the dealer, the bust card is discarded and the dealer begins hand (b) with a points value of six.

The process of drawing further cards or standing is repeated for hand (b). All wagers are then settled and play continues with all cards counting towards hand (c).

A blackjack (an ace and a value card of ten) can be achieved on hand (b) and a bonus payout of 6-5 or 6-4 may apply. All wagers are paid at one for one.

A double blackjack (an ace with two value cards of ten), may apply to hand (c) and further bonus payout may be applied.

Player may be allowed to place wagers on just any one, two or all three hands.

### Additional Game Play

### Triple Play

Players have the option before the deal to wager on winning all three hands against the dealer. If the player chooses this option, the “Triple Play” option is introduced and player must win or tie all three hands to ensure a return on the wager. All winnings during Triple Play” stay active until hand (c) has been played and outcome determined. For example, a one-unit wager will pay at least 7 to 1 if player wins all three hands. If player wins two hands and ties one hand, one unit will pay 4 to 1. Winning one hand and tie on two hands pays 1 for 1. If player loses one hand—the wager is lost.

### Double Blackjack

When a player is dealt an ace on hand (a), the player has the option to go for a double blackjack—meaning that the player must draw two further cards with a value of ten. If choosing this option, the dealer acknowledges a Double BJ option along with the payer's wagers.

If the first card is not a value of ten—player loses all wagers.

The odds for this payout will be dependent on the final math.

A double blackjack may also apply without the player doubling down and pay a further bonus. This would apply when a player is dealt ace on hand (a) followed by two value cards of ten on hands (b) and (c).

### Optional Side Wager

The optional side wager pays odds for a player to win all three hands against the dealer. This may range from between 4 to 1 and 7 to 1. If a player wins all three hands comprised of an ace in hand (a) and with a value card of ten on hand (b) and hand (c), the payout will be closer to 25 to 1. These will be dependent on the final math.

An addition to this optional wager would be to introduce further payouts by including ties.

### Ace Double Down

When a player is dealt an ace on hand (a) player may place a further wager to be dealt a double blackjack—meaning that the next two cards will both be cards with a value of ten. The odds for example may be 10 to 1. The original wager plays to the standard game and rules.

This side wager may pay lower odds for a double blackjack but also include a payout if player makes at least one blackjack. For example, one blackjack will be a push and double blackjack may pay 2 to 1 or 3 to 1. All other outcomes and dealer wins.

Doubling down may be allowed on hands (b) and (c).

### Triple Play Blackjack—Version Two

In this version, the first hand becomes a one-card race between player and dealer. The highest card wins with Ace being highest and deuce being lowest. One option is to offer a blackjack-type bonus for a player winning the race with ace. In order to create a house advantage to allow for such a bonus, the dealer may push/tie all wagers on hand (a) when dealer is dealt a deuce or any other card that allows for a house edge to be introduced.

As an example to the above, if the dealer pushes all hand (a) with a six, the approximate house edge would be 2.36%. A dealer pushing with a dealer seven would offer an approximate house edge of 1.18%.

Depending on the math, a push may only apply when player and dealer are dealt the same value card.

If this version is applied to hand (a), the value of cards from highest to lowest value would be as follows. Ace, King, Queen, Jack, Ten, Nine, Eight, Seven, Six, Five, Four, Three and Deuce.

It may allow for a player to only tie or push with a dealer ace, meaning that the push on the deuce does not apply in such cases.

A “Tie Wager” may also be offered and may pay approximately 11 to 1.

With this version, hands (b) and (c) wagers play to the same format and rules as in version one. Also, any combination may be applied from any of the three versions.

In cases when dealer has drawn cards for hand (b) and it includes one or more aces to form a soft hand of 18 or more, the same value score may apply to hand (c). For example, if dealer points value on hand (b) is 18 and includes one or more aces, the dealer must draw at least one more card. In this example, if a dealer draws an ace, deuce or three, then the dealer points value will counts as 29 with an ace, 30 with a deuce and 31 one with a three.

Drawing any other card, the dealer rules would apply. The same rule may apply to the player, depending on the final math.

A commission may apply to hand (a) if that hand is played as a one-card race. There is also the option to apply a commission and pay a bonus for a player winning ace. For example, paying 6-5 of winning ace, the math suggests a player advantage of 1.42%. Therefore, a 3% commission would see a house advantage of 1.58%. Paying 3-2 on player winning ace suggests a 3.55% player advantage. Therefore, a 5% commission would equate to a house advantage of 1.45%. Another option is to offer players the option of paying less commission and no bonus, for example a 2% commission. Another option would be to apply commission on hand (a) or winnings only or any combination of the above.

### Triple Play Blackjack—Version Three

In this version, hand (a) may play to either of the first two versions, meaning it becomes a one-card race or played to 11 with rules from version one applying. Irrespective of which version is applied to hand (a), hand (b) also plays to the same rules and format of version one. The difference in this version is hand (c), with the outcome of this wager determined by means other than the 31 target used in both versions one and two. This may apply to non-digital, dealer-assisted games we see on the casino floor.

In the above two versions, hand (c) is played to a score closest to 31. By reducing this target, fewer cards will be drawn. One example is for hand (c) to have a target score of 22+, meaning that the first total reached on 22 or more would be the score for hand (c).

As an example, if playing hand (b) and to a target of 21, a player draws a card to bust, meaning the player has over 21, the bust score will be the players score on hand (c).

The 22+ can be altered to become 23+, meaning a player and dealer can draw cards up to and including 22.

If the target hand (c) becomes 24+, then player and dealer may draw further cards up to and including 23.

The target hand may expand to 25+ or 26+. In each case, player and dealer may draw further cards to which ever target has been set.

A bonus payout may apply to a player being dealt a natural 31 consisting of one or two cards with the value of ten.

In order to introduce further house and edge and to offer higher payouts on the bonuses, a dealer push on hand (c) can apply to whatever the target number. For example, if target score is 22+, then the dealer will push or tie all remaining wagers on 22. If target score is 23+, then the dealer will push or tie on all wagers on hand (c). The same applies to whatever the target score is set for hand (c).

In instances when the dealer reaches the push or tie mark when drawing a card to bust on hand (b), the dealer may also, depending on the math, win wagers on the same points value. For example, if push 22+ is in play, and dealer busts on hand (b) by reaching 22, all wagers will be settled for hand (b) and hand (c) is played out by players in order to draw a higher score than the dealer in order to gain a push. Tying the dealer in this case may result in dealer winning against the same points value.

Another options to reduce the number of cards in play is for the player and dealer to limit the draw on hand (c) to one card.

When player and dealer stand on hand (b) on a soft 18 or more, the ace may or may not count as eleven on hand (c).

A double down may be offered to players on hand (c) if wishing to draw a further card when player has reached the minimum target. For example, if hand (c) has been set a target of 22+, and player has 22, a double down may apply, depending on the final math.

Both player and dealer may, on the play during hand (b), score a total of 21 and a score of 31 by counting the ace as eleven. For example, a player dealt Ace, 3, 10 and 7, scores both 21 and 31.

Hand (c) could also be offered as a different game/outcome/target formed with the cards players have accumulated during the first two hands. For example, for the cards accumulated to create the best two or three card poker hand. Players and dealer will therefore draw cards that must not exceed 31 point and from cards create a poker hand. Drawing a card and going over 31 is a bust.

If a two card poker hand is chosen for hand (c), it would mean that an Ace and King of the same suit, with ace being the first card, would become a “natural” winner unless any of the three hands tie with the dealer. If the first card is king followed by a suited ace.

Another option is for the dealer to be allowed to draw one more card when reaching the minimum target such as 22+ before pushing all wagers. If dealer does not bust with the extra card, the dealer's points value will count and all hands settled accordingly. If dealer busts, then a push 22 may or may not apply if the feature is included and would also be dependent on the final math.

Another option for hand (c) is to draw to a max of 31 points but to use three cards to create a score closest to 21 but not over 21. Drawing cards to score over 31 is a bust.

### No Bust Triple Play Blackjack—Community Deal

This version of triple play blackjack uses a community deal of eight cards to determine the outcome to all three games of blackjack, playing to 11, 21, and 31. In this no bust version, players do not have any decisions to make and each hand draws further cards until the target score has been reached or exceeded. If exceeded, the score returns to the score prior to the card that exceeded the target.

For example, during hand (a) and the target of eleven points, if the player or dealer hand is less than eleven, the next card from the community deal will apply. If that card is a ten for example, then the only card that would improve hand (a) would be an ace counting as one, and that would create a score eleven. If the card is over an ace, then hand (a) would bust and so revert back to the no bust score of ten.

The same principle applies to both hands (b) and (c).

The community deal may consist of any number of cards from six upwards. In this example, however, the community deal will consist of 8 cards. Player and dealer may share one or more cards from the community deal. In this example deal, the player's hands begin from left to right and dealer's hands begin from right to left.

All wagers are placed prior to the deal. The 8 cards are dealt face down and are revealed depending the points score of the hand in play. If, on hand (a), the player card is revealed and then the dealer card. From hereon, the hand with the lowest points value begins to draw further cards until it has surpassed the total of the other hand.

For example, if player first card is a six and dealer card is a four, the dealer reveals another card until a bust has been achieved or the points total of the player hand has been surpassed. This applies to hands (b) and (c) also.

This example deal highlights how a deal and outcomes are determined. The eight community cards are as follows: 5-7-9-10-Ace-5-9-4.

In the above deal, players win hand (a) by a score of 5 to 4. For hand (b), player has a score of 21 while the dealer has a score of 19. For hand (c), player has a score of 31 while the dealer has a score 29.

In some instances, the player or dealer may utilize all eight cards but irrespective, eight cards would be the maximum in this example.

### Triple Play Baccarat

Triple Play Baccarat uses a community deal of two or more cards to create one or more baccarat hands. In order for this method to allow multiple hands, the player's hands begin from one end of the deal and the banker's hands from the opposite end.

In this example, a community board of six cards is dealt with the player's hand beginning from left to right or from right to left and the banker's hands from right to left or left to right. Irrespective, the banker's hand always begins from the opposite end to the player's.

The community deal is dealt face down and player may wager on any of the three baccarat outcomes that will be determined when all six cards are revealed.

In this example, the player's hands begin from left to right and banker's hand from right to left.

Players may place wagers on any of three baccarat hands, a, b or c. Once all wagers have been made, cards from the community deal are turned face up commencing with one card from the left and one card from the right.

In this example, the player's card is a 9 and banker's card is a 10. The next player card is a 5 and the banker's card is an 8. In this example, the banker has won hand (a). The player's third card is revealed and as is the banker's, and all three outcomes are now determined. In this example, the community deal is as follows, 9-5-10-5-8-10. Player or banker would therefore use cards from the community to create three baccarat hands. In all cases, player and banker will share cards from the community unless the number of cards on the deal are increased to the point that there is no need to share cards from the community deal. With a community deal of six cards, however player and banker will share cards.

The three outcomes in this example are determined in the following manner. In hand (a), banker wins with an natural 8 to player 4. In hand (b), player wins with 4 versus a banker 3. In hand (c), the player wins with a 9 versus a banker 3.

The three outcomes are determined by the following allocation of cards. Hand (a), player's cards are 9-5 for a score of 4. Banker scores a natural 8 with the 10 and 8. For hand (b), the player's hand uses the first three cards of 9, 5, 10 to score a total of 4. The banker uses three cards of 10-8-5 to score a total of 3.

For hand (c), players uses the first four cards of 9-5-10-5 to score a 9 while the banker uses four cards of 10-8-5-10 to score a total of 3.

On hand (a), both player and banker may draw a further card depending on the rules of baccarat to complete the hand. For example, if the banker did not begin the hand with a natural 8 and a further card was needed to determine the outcome, then for hand (b), player and banker would use four cards to determine the outcome. This would also mean that player and banker would use five cards to determine the outcome to hand (c).

As an example, the above community will contain a natural total and a further card will be used to determine hand (a). In this example, the community deal will see the final the bankers 5 and 8 change places. The deal therefore is as follows. 9-5-10-8-5-10.

In this example, the player score based on the first two cards is 4 and the banker's score is 5. In this case, both player and banker draw and so the third cards come into play. The score would therefore be based on the community deal and will be as follows: player 4 and banker 3. For hand (b), four cards each are used by player and banker, and the scores would be player 2 and banker 1. For hand (c), five cards will be used by player and banker and will produce a score of 7 for the player and a score of 8 for the banker.

By utilizing this method, it offers the opportunity to offer a variety of wagers including parlays, meaning doubles and trebles. Moreover, it allows for players to wager on Triple Play, which offers the opportunity for enhanced odds.

For example, a player may wager on the player to win all three hands. In this case, placing a one-unit wager, a player will receive odds of 7-1 for winning all three wagers. A one-unit wager becomes two units if winning hand (a), two units would then become 4 units for winning hand (b) and 4 units will become 8 units for winning hand (c).

A variety of other unique and optional wagers may apply, inducing a progressive jackpot for player and banker tie all three hands with a score of 9. Another would be a tie mini-paytable offering different payouts for player and baker tying one, two or all three hands.

Another paytable may be based on the total points scores for all three hands be on just the player's score or banker's score or a combined score.

In order to allow for further draws on hands b and c, the number of community cards may be increased to 7, 8 9 or even 10 cards.

Triple Play Baccarat may also be offered from a standard baccarat deal. Once the hand has been dealt and outcome determiner, the cards stay in place and player and banker are each dealt a further card to create a score for hand (b). The process is repeated to then create a score for hand (c).

For hands B and C, a house edge is introduced by the banker pushing on total scores of one for those two hands. To reduce the house edge, a bonus payout of 6-5 may apply to scores of player nine for hand B and C.

### Triple Play Pokerjack

Triple Play Blackjack games disclosed herein can be played in combination, and with cards in common, with a poker game, by modifying and/or extending game play as described in U.S. Pat. No. 8,708,792, “GAMING DEVICE AND SYSTEM AND METHOD FOR PROVIDING POKER-BLACKJACK GAME,” filed Feb. 14, 2012, which is hereby incorporated by reference to the extent that it does not contradict the explicit teachings of the instant disclosure, and wherein such incorporation does not include the claims of U.S. Pat. No. 8,708,792. Any suitable combinations of rules from Triple Play Blackjack games of the instant disclosure and poker-blackjack games disclosed in U.S. Pat. No. 8,708,792 can be practiced.

In some examples, blackjack hands of 11, or 21, or 31, or any combination of the three, can be played along with one or more poker hands, in which the same cards can apply to all wagers and outcomes.

### Player v Player Ring/Cash Game and Tournament Structure.

### Version One

In this version, four different pots are determined independently.

Pot 1

Will be won by the best total points score of eleven.

Pot 2

Will be won by the best possible points score of 21

Pot 3

Will be won by the best points score of 31

Pot 4

Will be won by the best three-card poker hand

The structure for both ring/cash games or tournaments may utilize a variety of betting structures and may include antes, set limit, pot limit and no limit.

A variety of dealing formats are possible and may include cards to players being dealt down or face up.

### Game Rules Version One

Pot 1—Score to Eleven

All card pip counts at face value with ace counting as one or eleven.

Each player places and ante and are dealt one card each face down. The object is for players to then draw further cards to in order to generate a score closest to eleven. With ties, it may be deemed that the winning hand will go to the player with most cards used to create eleven or least cards required to score eleven.

Pot 2—Score to 21

Once pot 1 has been determined, player will draw further cards in order to achieve a score of 21 or closest to 21. Before players draw further cards, all cards used in pot are revealed face up. Each further draw will see the cards dealt face down.

Winning hands will again be determined with the same rules as in pot one.

Pot 3—Score to 31

Players will again reveal all cards face up to this stage before drawing further cards to create a score closest to 31. Score over 31 are deemed to have bust if drawing a score totaling more than 31 and cannot win the hand. All cards drawn during this round are dealt face down to each player.

After each player has acted by drawing further cards, winning hands are determined for the score closest to 31 as with the rules for both pot 1 and 2 with either the least or most cards drawn deciding all ties.

Pot 4—Three-Card Poker Hand

At this stage, pot 4 is also decided with the best three-card poker hand winning.

Wagering may be allowed before or after each draw.

One wagering format may see each player placing one wager which will be split between the four pots.

### Version Two

In this version, the four different pots which are determined independently.

Pot 1

Will be won by the best total points score of eleven.

Pot 2

Will be won by the best possible points score of 21

Pot 3

Will be won by the best points score of 31

Pot 4

Will be won by the best one-card poker hand

Pot 5

Will be won by the best two-card poker hand

Pot 6

Will be won by the best three-card poker hand

The structure for both ring/cash games or tournaments may utilize a variety of betting structures and may include antes, set limit, pot limit and no limit.

A variety of dealing formats are possible and may include cards to players being dealt down or face up.

### Game Rules Version Two

Pot 1—score to eleven

All card pip counts at face value with ace counting as one or eleven.

Each player places and ante and are dealt one card each face down. The object is for players to then draw further cards to in order to generate a score closest to eleven. With ties, it may be deemed that the winning hand will go to the player with most cards used to create eleven or least cards required to score eleven.

Pot 4—one-card poker hand

At this stage, after pot 1 is decided, pot 4 is also decided with the best one-card poker hand winning.

Pot 2—score to 21

Once pot 1 has been determined, player will draw further cards in order to achieve a score of 21 or closest to 21. Before players draw further cards, all cards used in pot are revealed face up. Each further draw will see the cards dealt face down.

Winning hands will again be determined with the same rules as in pot one.

Pot 5—two-card poker hand

At this stage, after pot 2 is decided, pot 4 is also decided with the best two-card poker hand winning.

Pot 3—score to 31

Players will again reveal all cards face up to this stage before drawing further cards to create a score closest to 31. Score over 31 are deemed to have bust if drawing a score totaling more than 31 and cannot win the hand. All cards drawn during this round are dealt face down to each player.

After each player has acted by drawing further cards, winning hands are determined for the score closest to 31 as with the rules for both pot 1 and 2 with either the least or most cards drawn deciding all ties.

Pot 6—three-card poker hand

At this stage, after pot 3 is decided, pot 4 is also decided with the best three-card poker hand winning.

Wagering may be allowed before or after each draw.

One wagering format may see each player placing one wager which will be split between the six pots.

In some versions, each player can place wagers for each of pots 1-6 before any cards are dealt. In some versions, each player can place wagers for sub-combinations of Pots 1-6 before any cards are dealt. In some such versions, sub-combinations of pots 1-6 can be defined by the house. In some other such versions, each player can define their own sub-combinations of pots 1-6.

In some versions, players can decide whether to place wagers for some of the pots after dealing has commenced. For example, after pots 1 and 4 are determined, a player could decide whether to wager on any of pots 2, 3, 5, and/or 6.

In some versions, a player can choose not to wager any or all of the poker pots.

In some versions, a player can choose not to wager any or all of the blackjack pots.

### Electronics and System

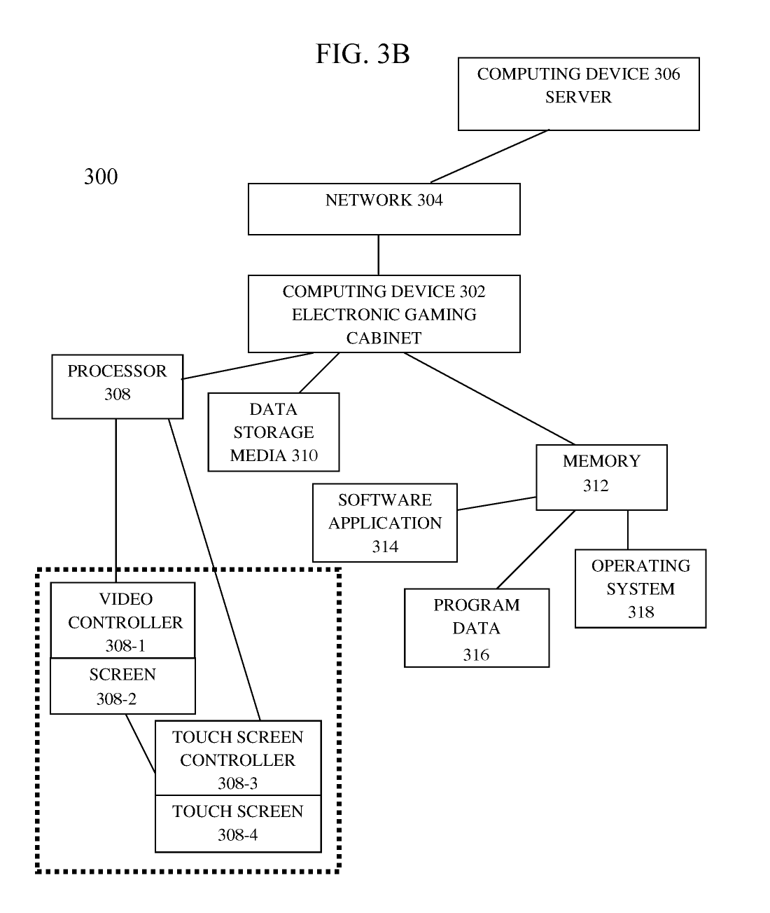

In some embodiments, the system described herein uses a computing system to carry out the various functions described herein. FIGS. 3A and 3B are schematic block diagrams of an example computing system 300. The example computing system 300 includes at least one computing device 302. In some embodiments the computing system 300 further includes a communication network 304 and one or more additional computing devices 306 (such as a server).

The computing device 302 can be, for example, located in a gaming establishment or can be a computing device 302 located in a user's home or office. In some embodiments, computing device 302 is a mobile device. The computing device 302 can be a stand-alone computing device or a networked computing device that communicates with one or more other computing devices 306 across a network 304. The additional computing device(s) 306 can be, for example, located remotely from the first computing device 302, but configured for data communication with the first computing device 302 across a network 304.

In some examples, as illustrated in FIGS. 3A and 3B, the computing devices 302 and 306 include at least one processor or processing unit 308 and system memory 312. The processor 308 is a device configured to process a set of instructions. In some embodiments, system memory 312 may be a component of processor 308; in other embodiments system memory 312 is separate from the processor 308. Depending on the exact configuration and type of computing device, the system memory 312 may be volatile (such as RAM), non-volatile (such as ROM, flash memory, etc.) or some combination of the two. System memory 312 typically includes an operating system 318 suitable for controlling the operation of the computing device 302, such as the WINDOWS® operating systems or the OS X operating system, or a server, such as Windows SharePoint Server, also from Microsoft Corporation, or such as a Mac Mini with OS X. The system memory 312 may also include one or more software applications 314 and may include program data 316.

The computing device 302 may have additional features or functionality. For example, the computing device 302 may also include additional data storage devices 310 (removable and/or non-removable) such as, for example, magnetic disks, optical disks, or tape. Computer storage media 310 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 310 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 302. An example of computer storage media 310 is non-transitory media.

In some examples, one or more of the computing devices 302 or 306 can be located in a gaming cabinet or video poker terminal located in an establishment, such as a casino or bar. A schematic diagram of such a device is shown in FIG. 3B. The computing device 302 and 306 may be an electronic gaming machine with input device options including, but not limited to, a video controller 308-1, a screen 308-2, a touch screen controller 308-3, or a touch screen 308-4.

In other examples, the computing device 302 can be a personal computing device that is networked to allow the user to play card games disclosed herein from a remote location, such as in a user's home or other location.

In some embodiments, the computing device 302 is a smart phone, tablet, laptop computer, personal digital assistant, or other mobile device. In some embodiments, system operations and functions are stored as data instructions for a smart phone application. A network 304 facilitates communication between the computing device 302 and one or more servers, such as an additional computing device 306, that hosts the system. The network 304 may be a wide variety of different types of electronic communication networks. For example, the network 304 may be a wide-area network, such as the Internet, a local-area network, a metropolitan-area network, or another type of electronic communication network. The network 304 may include wired and/or wireless data links. A variety of communications protocols may be used in the network 304 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 306 is a Web server. In this example, the first computing device 302 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 308 of the one or more computing devices 302 or 306, the instructions cause the processor 308 to perform one or more of the operations or methods disclosed herein. Examples of operations include the operations of game play and enforcement of one or more rules of the game.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method of playing a card game with players and dealer in a computing system comprising at least one server to host the card game and at least one computing device communicably coupled to the at least one server through a communication network, the method comprising:
using a card deck of 52 cards comprised of four sets of ace through king, wherein a first set of ace through king displays a first suit, a second set of ace through king displays a second suit, a third set of ace through king displays a third suit, and a fourth set of ace through king displays a fourth suit;
dealing cards to at least one player and a dealer, wherein:
a first player card is dealt face up to a player and applies to a first player hand, a second player hand, and a third player hand;
a first dealer card is dealt face down to a dealer and applies to a first dealer hand, a second dealer hand, and a third dealer hand;
the player indicates whether to draw a second player card for the first, second, and third player hands;
the dealer reveals the first dealer card to determine whether to draw a second dealer card for the first, second, and third dealer hands;
a first winner is determined, wherein the winner is the player or dealer with closest to 11 points;
the player indicates whether to draw an additional one or more cards for the second and third player hands;
the dealer determines, based on predetermined rules, whether to draw an additional one or more dealer cards for the second and third dealer hands;
a second winner is determined, wherein the winner is the player or dealer with closest to 21 points;
the player indicates whether to draw an additional one or more cards for the third player hand;
the dealer determines, based on predetermined rules, whether to draw an additional one or more dealer cards for the third dealer hand;
a third winner is determined, wherein the winner is the player or dealer with closest to 31 points; and
a fourth winner is determined, wherein the winner is the player or dealer with the highest three-card poker hand.

2. A method of playing a card game with players and dealer in a computing system comprising at least one server to host the card game and at least one computing device communicably coupled to the at least one server through a communication network, the method comprising:
using a card deck of 52 cards comprised of four sets of ace through king, wherein a first set of ace through king displays a first suit, a second set of ace through king displays a second suit, a third set of ace through king displays a third suit, and a fourth set of ace through king displays a fourth suit;
dealing cards to at least one player and a dealer, wherein:
a first player card is dealt face up to a player and applies to a first player hand, a second player hand, and a third player hand;
a first dealer card is dealt face down to a dealer and applies to a first dealer hand, a second dealer hand, and a third dealer hand;
the player indicates whether to draw a second player card for the first, second, and third player hands;
the dealer reveals the first dealer card to determine whether to draw a second dealer card for the first, second, and third dealer hands;
a first winner is determined, wherein the winner is the player or dealer with closest to 11 points;
the player indicates whether to draw an additional one or more cards for the second and third player hands;
the dealer determines, based on predetermined rules, whether to draw an additional one or more dealer cards for the second and third dealer hands;
a second winner is determined, wherein the winner is the player or dealer with closest to 21 points;
the player indicates whether to draw an additional one or more cards for the third player hand;
the dealer determines, based on predetermined rules, whether to draw an additional one or more dealer cards for the third dealer hand;
a third winner is determined, wherein the winner is the player or dealer with closest to 31 points.
